(19) United States
(12) Patent Application Publication
(10) Pub. No.: US 2015/0122216 A1
(43) Pub. Date: May 7, 2015

(54) METHOD AND SYSTEM TO IMPROVE ATOMIZATION AND COMBUSTION OF HEAVY FUEL OILS

(71) Applicant: HELPFUL TECHNOLOGIES, INC., Lauderdale, FL (US)

(72) Inventors: Victor Gurin, Hilton, NY (US); Mindaugas Macijauskas, Boca Raton, FL (US); Pavel Pikul, Rochester, NY (US); Serguei Permiakov, Kanata (CA); Mark Goltsman, Rochester, NY (US); Igor Gachik, North Delray Beach, FL (US)

(21) Appl. No.: 14/400,208

(22) PCT Filed: May 11, 2013
(86) PCT No.: PCT/US2013/040686

§ 371 Date: Nov. 10, 2014

Related U.S. Application Data
(60) Provisional application No. 61/645,711, filed on May 11, 2012.

(51) Int. Cl. F02D 19/06; F02M 37/04; F02M 31/20; F02D 19/08; F02M 37/00

(52) U.S. Cl. CPC F02D 19/0605; F02D 19/0642; F02D 19/0663; F02D 19/081; F02M 37/0064; F02M 31/20; F02M 37/04
USPC 123/25 E; 123/525; 123/541

(57) ABSTRACT

Presented a method and a system for improving atomization of heavy fuel oil or diesel fuel in heavy duty diesel engines, e.g. marine engines, wherein before injection into a combustion chamber the fuel is treated by gas/gases under elevated pressure of about 500 psi in an absorber; the heavy fuel oil/diesel fuel is fed to the absorber's dispensing means at a pressure of 1100 psi; a resulted fuel solution without a free gas phase is further mixed with a recirculating fuel stream forming a mixed fuel stream; the mixed fuel stream is directed for injection into a combustion chamber.

### CROSS REFERENCES TO RELATED APPLICATION

The invention described herein is directly related to the earlier filed Provisional U.S. Application No. 61/645,711, entitled “Method and system to improve atomization of heavy fuel oil”, filed May 11, 2012. The provisional application is incorporated herein by reference thereto.

### FIELD OF THE INVENTION

This invention relates to the field of engine engineering, in particular—fuel delivery systems in diesel engines operated on both heavy oil fuel (fuel oil) and conventional diesel fuel. The invention applies to resource-saving and environment-friendly fuel systems and is primarily intended for application in low-speed marine diesel engines where liquid hydrocarbon fuels, such as, for example, fuel oil, diesel fuel, biofuel, furnace oil, oil, etc., are burned.

### BACKGROUND OF THE INVENTION

In the last 30 years active studies of the potential improvement of various types of engines have been carried out because of the abrupt increase in prices for all types of petroleum-based fuels. Using the most inexpensive fuel—fuel oil—does not remove the problem of fuel efficiency in engines since, for example, the cost of fuel makes up more than 50% of the total cost of sea transportation in the last 10-15 years. In addition to the cost considerations, environmental safety is of great significance. For instance, due to low efficiency of fuel oil combustion in marine engines, all cruise liners prior to entry in a port are required to replace the engine fuel with expensive sulfur-free diesel fuel and turn on costly exhaust gas scrubbers in order to reduce emissions of nitrogen oxides (NOₓ). The ship engines operate under these requirements as long as the ship stays in the harbor. And yet, any observer can see a dark area above a vessel in a port—emissions of soot-containing gases.

During the primary time of marine engine operation on fuel oil when the engine works under load and the ship is en route, emissions of soot, NOₓ, CO₂ and unburned hydrocarbons is troublesome and calls for effective solutions.

In order to understand the great significance of this problem, it is worth to point out that, for example, when a diesel engine that is not equipped with costly exhaust treatment devices works on diesel fuel of grade A2 at 3,300 horsepower, the exhaust makes up 547,000 ft³/hour (˜60,000 m³/hour). This exhaust contains
NO_{R}—32 kg/hour
CO₂—1580 kg/hour
Soot—2.47 lb/hr (when Load 3,300 HP).

If fuel oil is used instead of diesel fuel the exhausts are much worse.

Improvement of fuel combustion efficiency and reduction of emissions can be achieved using technical solutions for the initial processing of fuel by mixing diesel fuel or fuel oil with water with the addition of emulsifiers and stabilizers that ensure applicability of the produced water-fuel emulsion is good for five-seven days (e.g., see U.S. Pat. No. 7,645,305 B1 or U.S. Pat. No. 7,731,768 B2. In other solutions for high horsepower engine, it has been proposed to include a water-fuel emulsion making system for operational application to the engine; the content of water and other additional components is up to 40% of the total mass of produced emulsion (see, for example, U.S. Pat. No. 6,530,964 B2).

Water-fuel emulsions as alternative highly efficient fuel, both petroleum-based and synthetic, have been studied for the last 55 years. Researchers strongly recommend the use of WFE applications, including those with very high content of water (up to 45%), especially when burning heavy petroleum fuels in heating units. WFE applications in internal combustion engines have been studied as well, above all—in large power generators and marine engines. These studies were carried out in major companies such as Caterpillar and MAN. It is also known that similar studies have been conducted at Volvo in order to explore WFE applications in high-speed diesel engines with horsepower up to 575 HP.

The main difficulty WFE applications face is due to the fact that, as a rule, prepared emulsion soon starts releasing water, i.e. water separation takes place.

WFE applications have not been widely used in the market except in agricultural machinery that operates in short time intervals, which require filling their fuel tanks once or a few times a day. In these conditions of the local operation of agricultural machinery, it is beneficial to fill the tank with emulsion that can be produced in a “home-made” fashion using inexpensive components: emulsifiers and stabilizers that help making sustainable emulsion which can last for 5-7 days under vibrations and shaking that take place during machinery operation. After finishing the work cycle, this machinery is filled with base fuel and the entire system is rinsed of unwanted components—water and emulsifiers.

Using binding agents (emulsifiers and stabilizers) is not favorable either since it adversely affects engine exhaust and reduces service life of pumps and injectors. However, for inexpensive engines, such as those used in agricultural machinery, this shortfall is offset by very high diesel fuel economy that reaches 16%.

In some studies and published patents technical solutions have been shown for WFE making technologies where no emulsifiers and stabilizers are used. In patent RU No. 2381 826 C1, 2010, WFE Making System for ICE was presented where, as claimed, the problem of physical-chemical stability of WFE was solved without the use of binding agents. The solution was achieved through a novel design of a mixing device and a unit where water is dispersed in base fuel, as well as due to multiple circulations that facilitate thorough mixing of hot fuel emulsion surplus returned from the engine after injection prior to sending it to the high pressure pump of the basic fuel delivery system.

According to the claim by the inventors of this invention the novelty of the diesel fuel mixing and water dispersion devices is in the use of an ultrasound wave disperser that ensures extensive turbulization of the recycling emulsion flow.

In another similar solution suggested in patent RU No. 2,381,826 C1, 2012, production of emulsifier-free WFE (i.e., without the use of additional components—emulsifiers and stabilizers) is achieved using a jet device to introduce water into the fuel stream and then the fuel-water mixture is fed to the proportioning mixer where a hot return flow of emulsion that remained unused in the engine is also supplied. The system proposed by the inventors for application in engines is extremely complicated as it contains a recycling regulator in the fuel delivery line, as well as a sophisticated special hydraulic effector installed in the parallel water injection line to control the water supply to the jet mixers. The complexity of controlling such a hydraulic effector and the entire system is obvious because it necessitates supplying emulsion with rather a certain composition and certain content of each component of the engine with the requirement of ensuring optimal proportions when mixing three components in the proportioning device: a) base fuel; b) return flow of the excessive hot emulsion from the engine; and c) fresh mixture from the jet pump.

A comprehensive solution for a fuel emulsion production system where a pre-set concentration of two components prior to delivery to injection pumps is maintained was first discussed in U.S. Pat. No. 4,388,893 Diesel Engine Incorporating Emulsified Fuel Supply System, filed on Jan. 21, 1983.

In this system three recycling loops are used, each loop equipped with independent pumps that pump fuel, water and the return flow of emulsion from the injection pumps through a mixing chamber. Water is supplied to the mixing chamber through a proportioning valve controlled by a dedicated controller based on signals coming from the foot throttle and speedometer sensors. At the second stage of mixing of the initially prepared mixture fuel is introduced to it immediately prior to its supply to the injection pumps and the delivered further to injection into combustion chambers. The second mixing process is also governed by the dedicated controller.

PCT/EP2006/008496 describes a device to make an emulsion (diesel fuel+water) comprising a static mixing system, an homogenizing valve having an outlet port of small size and first, second and third high pressure cylinders with working pressure of 2000 bar. Diesel fuel and water are pre-mixed in the static mixing chamber to obtain a raw emulsion and are directed to a device comprising three high-pressure cylinder chambers. The inlets of the first high-pressure cylinder and the second high-pressure cylinder are connected to the water/diesel fuel raw emulsion mixing chamber, the outlets of the first high-pressure cylinder and the second high-pressure cylinder are connected to the homogenizing valve, the inlet of the third high-pressure cylinder is connected to the outlet of the homogenizing valve, and the outlet of the third high-pressure cylinder is connected to the diesel engine. The three pistons of the three high-pressure cylinders are part of a pressure booster which is connected to a hydraulic drive unit. The significant drawbacks of this system are high energy requirements and the necessity of the rigid kinematic connection with the crankshaft of the engine which results in inefficient operation at variable revolutions of the crankshaft and engine loads. Considerable shortcomings of this design are high energy cost and the need for rigid kinematic connection with the engine crankshaft, which translates into low efficiency when operating at variable crankshaft speed and engine loads.

An engineering solution shown in U.S. Pat. No. 7,281,500 Additional Fuel Slurry Delivery and Atomization System” is relevant to the new solutions claimed herein. This patent discusses the preparation of water phase of slurry made in the form of fine particles of coal in water for injection into combustion chambers. This slurry consisting of an atomized solid phase in water phase which is supplied to a contact chamber where it contacts with dispensing gas at pressure significantly greater than that in combustion chambers at the time of injection. The slurry, containing suspended solid matter at lower pressure, separates into small combustible particles that do not stick together because gas is released from the gas-water solution. This makes a significantly greater area of distributed fuel particles available for contact with hot air in the combustion chamber. In this case, the fuel slurry combustion is more rapid and full.

The patent describes a vessel for dissolution of dispersing gas in the water phase of the slurry in a contact chamber at high pressure that, preferably, is much greater than the combustion chamber pressure at the time of slurry injection.

Dispersing gas is introduced into the bottom zone of the contact chamber coming in the direction opposite to that of the flow of water phase with suspended finely dispersed solid phase.

Applying this technology of gasification of water phase containing suspended solid phase of fine particles of fuel allows reducing apparent viscosity of the slurry and improve the injection process. When using water-fuel slurry with finer particles of coal in water the apparent viscosity of slurry increases. Injection of such slurry results in larger droplets in the combustion chamber. It causes subsequent sticking (agglomeration) of coal particles within each droplet of water phase, which results in slower an inefficient combustion. The author of this patent believes that water phase gasification removes these shortcomings.

The apparent drawback of this solution that prevents this technology from being used is that it does not solve the problem of return flow of hot fuel slurry from the engine. Recycling arrangements for dispersing gas in the contact chamber and changing the content of the chamber by periodic purging are not discussed either. The inventor does not mention the modes of engine shutdown and long-term storage of the slurry in fuel delivery lines, pumps and injectors.

The present application is aimed at the improvement of fuel combustion efficiency.

### SUMMARY OF INVENTION

The present application is aimed at improvement of fuel efficiency in high horsepower engines running on heavy oil fuel through improvement of combustion processes and addition of cheap incombustible components to the process.

This objective is achieved through the use of saturation of heavy viscous fuel with gas/gases as well as, preferably, simultaneous saturation of a water phase with gases; this water phase is introduced in the fuel preparation process in optimal proportions.

Burning water-fuel oil emulsions in boilers is a well-studied process that ensures highly efficient fuel combustion; water addition is up to 40%. A shortcoming here is a low stability of the emulsion: separation of the two liquid phases (fuel oil and water) takes place in a matter of few minutes. The addition of emulsifiers and stabilizers defer this separation to a few dozen of minutes.

This limitation is not critical when fuel is delivered to a dispersion in a burner of a boiler plant since there so-called blind delivery used (fuel comes to injectors only, no return flow of fuel downstream of the injectors). In such units injectors are installed rather far from high temperature zones.

In diesel engines' fuel delivery systems injectors are located in the maximum temperature zones and, therefore, for lubrication and cooling of the injectors a return line from the engine is arranged, as well as an increased flow rate of the fuel that exceeds several times its flow rate of combustion in the engine. Thus, unstable emulsion cannot be used in internal combustion engines because disintegration—release of water phase takes place in the hot zone. This causes corrosion of critical components of the engine: valves, pumps and injectors, especially when the engine is shut down.

Using binding agents (emulsifiers and stabilizers) is not favorable either since it adversely affects engine exhaust and reduces service life of pumps and injectors. However, for inexpensive engines, such as those used in agricultural machinery, this shortfall is offset by very high economy (up to 16%) of expensive diesel fuel.

The proposed solution is applied to, for example, marine engines running on fuel oil, both four-stroke and two-stroke. In this solution fuel oil after filtration and pre-heating to about 220° F. (105° C.) is supplied to an absorber for dispersion at a gauge pressure up to about 35 bar (515 psi) of gases, e.g. air or natural gas with CO₂ or a mixture thereof. The fuel (preheated fuel oil) is supplied to the absorber at a significantly greater pressure of up to about 75 bar (1100 psi). This dispersion results in a large area of contact between the fuel and gases and vigorous sorption of gases in the liquid phase (fuel oil) takes place. This makes a saturated solution of gases in liquid fuel that is fed to injection into the combustion chamber. Compressed air pressure in combustion chambers of marine engines reaches about 90 bars (˜1320 psi) and the temperature is as high as about 1560° F. (850° C.). At that moment the injected charge of fuel is subjected to impact of two supercritical factors that affect the fuel solution and gas simultaneously. The charge of the solution experiences hydrodynamic breakage at its dispersion that occurs under high temperature in the combustion chamber. These two factors acting together cause active desorption of the dissolved gas in any arbitrarily small microdroplets of the fuel solution. Continuous release of dissolved gases results in a chain process of the liquid phase of the solution. This precludes fuel microdroplets from sticking together (coalesce) and prevents formation of a film of fuel on the combustion chamber walls. Fuel transfer from liquid to vapor phase is very rapid due to a superfine radii of the microdroplets, which facilitates fast ignition and efficient combustion of the injected dose of the fuel solution at the optimal volume of the combustion chamber. This combustion features considerable consumption of fuel (up to 12%), as well as total exhaust volume reduction up to 17% and reduction of soot emissions up to 80%.

The new technology is abbreviated as “A*2” (amplified atomization). Tests have proved the validity of the aforementioned parameters of sorption and desorption of gases, including applications where marginally soluble air is used to make solution “diesel fuel-air”.

Further development of this technology is presented with a solution for making water-fuel oil emulsion based on the process of sorption of gas/gases simultaneously in two immiscible liquid phases: reduced viscosity fuel oil and water. Experiments have shown that simultaneous dispersion of these liquids in a closed space at an excess pressure of mixed gases while maintaining optimal proportions of the mixing liquid phases produce highly stable fuel oil-water or diesel fuel-water emulsion with water content up to about 15.5%. This emulsion remains stable in the open air at high temperature up to about 205° F. (95° C.). Road tests run under actual engine operating conditions have shown fuel economy improvement up to 15-18.3%, reduction of emissions of exhaust gases up to 25% and reduction of soot emissions up to 90%.

Two configurations of emulsion operation were tested in the above experiments with the new fuel delivery system. The first configuration emulsion was made in the absorber and the flow of return emulsion from the engine is also sent to the absorber. Water-fuel emulsion is returned using a low pressure recirculation pump. The return flow of fuel emulsion coming from the engine is cooled down in a heat exchanger and sent to a relief valve, which increases the fuel solution stream pressure in injection lines at least by about 15% as compared to gas pressure in the absorber when making the emulsion. Increased pressure in the injector feed lines is set in order to avoid releasing dissolved gases. In the first configuration option the stream of cooled return fuel solution downstream of the relief valve comes back to the absorber. This makes a closed loop for recirculation of fuel solution or emulsion through the absorber. Hot fuel solution is cooled in the exchanger by pumping standard unheated fuel oil through the cooling space of the exchanger and the fuel is returned to a standard mixing tank. Fuel from the mixing tank is sent to the absorber by a standard recirculation pump to fuel oil heaters. Part of heated fuel downstream of the heaters is fed to the absorber by a pump that creates pressure of 75 bar (1100 psi) at the dispersers. The pump that drives fuel oil to the absorber is governed by a controller operating based on control signals coming from an external unit containing fuel emulsion level sensors. Synchronized supply of water to dispersion in the gas space of the absorber is arranged using an additional pump operated by the controller. If needed, part of the produced emulsion is taken to an indicator and further to a water surplus tank through a bottom port of the absorber by switching a two-way valve. The gas space of the absorber is periodically purged in order to change gases and the blown gases are sent to the engine air intake duct preferably downstream of the turbocharger.

An embodiment of the present invention comprises a fuel activation system for marine engines. The system comprises an absorber having an inlet port with dispersing means for receiving heavy fuel oil from a base fuel supply system after heaters; a first inlet port with a dispersing means for receiving water; a second inlet port for receiving a gas to be dissolved in liquid phase; an output port for discharging a resulting “water-fuel/gas” emulsion; a gas venting port for periodical venting of the gas section of the absorber. A feeding pump pumps heavy fuel to the absorber and creates enough pressure to provide satisfactory dispersion of heavy fuel by the dispersion means. An outside block of sensors controls a level of “water-fuel/gas” emulsion and an emergency means inside the absorber. A recirculation supply pump pumps the “water-fuel/gas” emulsion discharged from the absorber to the base fuel supply lines. A cooling cools a return “water-fuel/gas” emulsion and pressure relief keep a pressure in the fuel supply lines and prevent formation of a free phase of gas from the “water-fuel/gas” emulsion.

The fuel activation system further comprises the absorber having an inlet port for receiving the return “water-fuel/gas” emulsion flow from the engine and the discharge port is in fluid connection with the base fuel supply system through an ultrasonic actuator for providing local pressure reliefs thus destroying fuel/gas sorption links without releasing a free phase of gas in the “water-fuel/gas” solution output flow.

The fuel activation system further comprises a gas separator for separating free gas/fuel vapors in the return “water-fuel/gas” solution flow; an Y-connector for mixing the return “water-fuel/gas” emulsion flow with the fresh “water-fuel/gas” emulsion flow from the absorber; the resulting mixed “water-fuel/gas” emulsion flow is directed to the base fuel supply system by a recirculation supply pump. The fuel activation system uses water which is de-ionized, purified, or desalinated water.

In the present fuel activation system the gas/gases is fed to the absorber under the pressure of about 500 psi (35 bars). The heavy fuel can be pumped to the absorber at a pressure of about 1100 psi (75 bars) and taken from a point after heaters and viscosity unit at temperature 185° F. (85° C.). The heavy fuel and water is dispersed simultaneously in optimum proportions in the absorber's top area, and a quality of the emulsion is periodically controlled by the presence of separated water in an indicator of transparency of emulsion.

The present invention further comprises a method of improving the atomization of heavy fuel oil or diesel fuel. Before injection into the combustion chamber, the fuel is treated by gas/gases under elevated pressure at about 500 psi (35 bars) in the absorber. The resulted fuel solution does not have a free gas phase. The prepared fuel solution is further mixed with recirculating fuel stream and the mixed fuel stream is directed for injection.

### BRIEF DESCRIPTION OF THE DRAWINGS

FIG. 1 shows a schematic diagram of the A*2 system with the return of the excess fuel solution from the engine to the absorber.

FIG. 2 shows a schematic diagram of the A*2 with arrangement of close recirculation contour by mixing the excess fuel solution from the engine with fresh fuel solution from the absorber.

### DESCRIPTION OF THE INVENTION

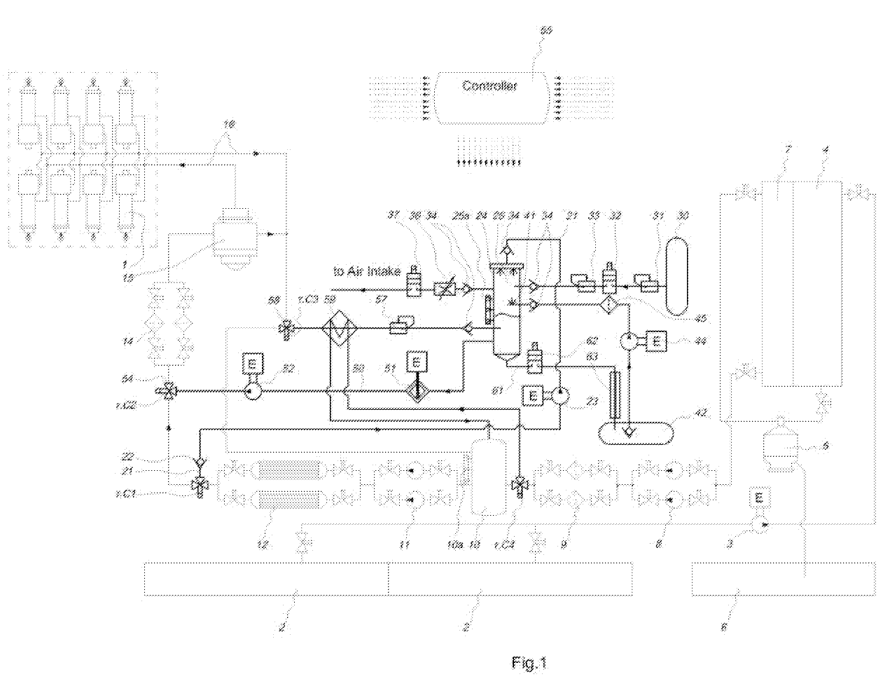

Referring to the FIG. 1 the base fuel supply system of a marine engine 1 operates as follows: the heavy fuel oil (hereinafter, HFO) is transferred by a transfer pump 3 from a fuel bunker tank 2 to a fuel settlings tank 4. From the fuel settlings tank 4 the HFO is supplied to a fuel purifier 5 to separate clumps and impurities having a size more than 10 microns that drain to a sludge tank 6. The ready to use purified HFO is transferred to a fuel service tank 7. Fuel feeding pumps 8 pump the HFO to a mixing tank 10 through first stage fuel filters 9. Fuel circulation Pumps 11 pump the HFO through fuel heaters 12 and second stage fuel filters 14 to a fuel injection pump 15, which delivers it to fuel injectors of the marine engine 1 under injection pressure of 300 to 350 bar. To provide the required viscosity and optimal atomization of the HFO in combustion chambers it is heated by fuel heaters 12 to a temperature of at least 275° F. (135° C.). The fuel is supplied to the engine in surplus to provide lubrication and cooling of the injection pump 15 and fuel injectors. The excess fuel is returned from the engine though a return line 16 to the mixing tank 10.

The A*2 system is connected to the base marine engine fuel supply system in 4 points using 3-port switchover valves, preferably ball valves, that controlled by a controller 55. Normally open ports commute the base fuel supply system.

In economical mode to prepare a HFO solution the changeover valve in point C1 is switched over by a command of the controller 55 as to send the HFO for additional treatment by the A*2 system though a feed line 21 with check valve 22. A feeding pump 24 delivers the HFO to a dispersing means 24 of the absorber 25 under pressure. A check valve 27 is installed upstream the dispersing means 24 to prevent backflow in the line 21.

A gas, e.g. air, methane, natural gas, or a mixture thereof from the gas source 30 is delivered to the absorber 25 through a solenoid valve 32, a pressure reducing regulator 33, and a check valve 34. The gas removal and periodic venting of the gas section of the absorber 25 is performed though a check valve 35, an orifice 36, and a solenoid valve 37. The venting gas is supplied to an air intake of the engine (not shown), preferably after the turbocharger.

The absorber 25 may also have water dispersing means 41 for preparing an emulsified HFO solution. The water is supplied to the water dispersing means 41 from a water storage tank 42 though a check valve 43, a water filter 45 by a water supply pump 44.

The prepared in the absorber 25 the HFO solution or emulsified HFO solution is delivered through a line 50 and a flow activator 51 by a recirculation low pressure pump 52 which increases the flow pressure, to a point C2 with a switchover valve 54. In economical mode the normally open port of the switchover valve 54 that commutes the base fuel supply lines is closed and the normally closed port is open to send the HFO solution or the emulsified HFO solution under increased pressure to the second stage fuel filters 14 and further to the injection pump 15 of the marine engine 1. As injectors have a high temperature to exclude gas release from the HFO solution the pressure of the supplied HFO solution in fuel supply line to injectors is increased in not less than 13.5% using an upstream pressure relief valve 57.

The return flow of HFO solution or emulsified HFO solution from the engine 1 is directed to a point C3 with a switchover valve 58 having in the economical mode the normally closed port open and the return excess HFO solution/emulsified HFO solution flows through a heat exchanger 59, pressure relief valve 57, and check valve 56 to upper zone of the absorber 25.

Water that may separate from the emulsified HFO is collected at the bottom zone of the absorber 25 and drains to the water storage tank 42 though a solenoid valve 62, and a water indicator 63.

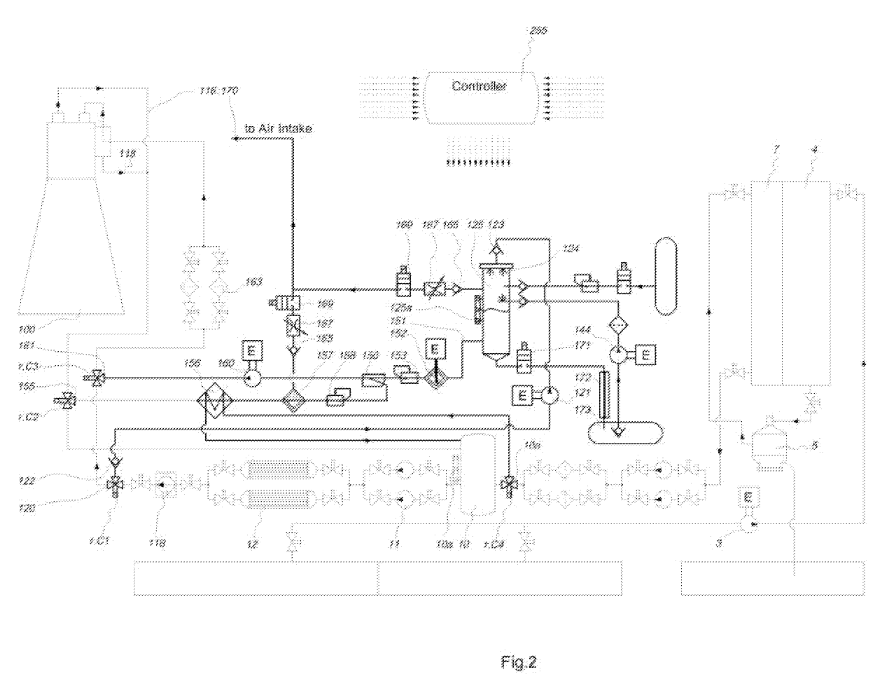

Referring to the FIG. 2 another embodiment with a new arrangement of HFO solution/emulsified HFO solution flows is shown. In this embodiment the hot returned flow of HFO solution/emulsified HFO solution from the engine 100 is mixed with fresh HFO solution/emulsified HFO solution from the absorber 125 in a special device, Y-connector 150 outside the absorber. The fresh HFO solution/emulsified HFO solution from the absorber 125 flows through a line 151 to a flow activator 152 where it is subject to, e.g., ultrasonic treatment by magnetostriction oscillator to partially destroy the bonding links between liquid and gas molecules. After treatment in the flow activator 152 the HFO solution/emulsified HFO solution flows through a pressure reducing regulator 153 to the first inlet port of the Y-connector 150. The return hot excess HFO solution/emulsified HFO solution from the engine 100 flow through a return line 116 and switchover valve 155 to a cooler 156. The cooled return flow is directed to a gas separator 157 to separate free gas/fuel vapors that may escape from the returned fuel solution and further through a pressure relief valve 158 to a second inlet port of the Y-connector 150. The pressure relief valve 158 and a recirculation pump 160 installed downstream the Y-connector 150 ensure upstream pressure increase.

In this device (Y-connector) two paired streams are mixed together. Here the flow with lower flow rate is infused into the high flow rate stream of the return flow. The use of the Y-connector 150 allows preventing the release of gases in the process of mixing the streams and formation of stagnation zones or countercurrents.

Therefore, release of gases in this embodiment is prevented by using the recirculation pump 160 that supplies fuel to the engine 100 via three-port switchover valve 161 and fine filters 163 along with a pressure relief valve 158, providing pressure increase in the delivery lines to the injectors by more than 15% relative to the absorber pressure. Otherwise, if gas emerges in the fuel delivery lines, it will affect the fuel charging and cause engine knocking and breakdown. Free gas and fuel vapors released in separator 157, as well as venting gases from absorber 125 are sent through corresponding check valves 165, orifices 167 and solenoid valves 169 through a loop 170 to an engine air intake. Cold HFO flow that comes through 3-way switchover valve 10a installed in point C4 located upstream of mix tank 10 is used as a coolant in the cooler 156. This cooling fuel, passed through the cooling portion of the cooler 156, is sent to mix tank 10 and then further, using pumps 11, to heaters 12 to ensure lower initial viscosity prior to be fed to the fuel preparation process. It is recommended to install viscometer 118 where the fuel comes out of the heaters in order to regulate temperature in the heaters. Downstream of the viscometer 118 the stream comes to 3-way switchover valve 120 installed in connection point C1; its normally open port of the standard line is closed when working on fuel solution/emulsion. At the same time another port of 3-way valve 120 is open to supply fuel to absorber 125. When feed pump 121 is activated by a command coming from controller 255, heated fuel from the switchover valve 120 is pumped by pump 121 through check valves 122 and 123 to the absorber head and is dispersed through dispersing means 124. Upon activation of feed pump 121 the pressure at the dispersing means increases up to 75 bar (1100 psi). Pump activation signal is sent based on readings of level sensors unit 125a installed externally with respect to the absorber.

In the course of water-emulsion mixture making, fuel oil dispersion in the absorber is accompanied with deionized water in optimal proportions. This is done using a water pump 144 that builds pressure up to 75 bar (1100 psi). Tests have been run showing that simultaneous sorption of gases in two immiscible liquids results in forming sorption bonds between multiphase molecules of fuel and water. Highly stable emulsion contains dispersed water phase with particles smaller than 1 micron. Emulsion quality control is maintained periodically by opening a solenoid valve 171 installed in the emulsion discharge line that comes from the bottom port of the absorber and sending emulsion to a quality indicator 172 and further to a water storage tank 173.

The embodiments shown on FIG. 1 and FIG. 2 depict a universal fuel delivery system for a high horsepower engines, e.g. for marine engines running on heavy oil fuels or conventional diesel fuel. This system is designed for making two types of fuel depending on engine load. For example, when the engine is running idle while the ship is parked in a port, diesel fuel is advisable in order to reduce emissions of poisonous components of the exhaust, while when the engine operates under maximum loads it is most beneficial to run it on water-fuel oil emulsion made using A*2 technology.

What is claimed is:

1. A fuel activation system for marine engines comprising:
an absorber having an inlet port with dispersing means for receiving heavy fuel oil from a base fuel supply system after heaters; a first inlet port with a dispersing means for receiving water; a second inlet port for receiving a gas to be dissolved in liquid phase; an output port for discharging a resulting “water-fuel/gas” emulsion; a gas venting port for periodical venting of the gas section of the absorber;
a feeding pump for pumping heavy fuel to the absorber and creating enough pressure to provide satisfactory dispersion of heavy fuel by the dispersion means;
an outside block of sensors to control a level of “water-fuel/gas” emulsion and an emergency means inside the absorber;
a recirculation supply pump for pumping the “water-fuel/gas” emulsion discharged from the absorber to the base fuel supply lines;
cooling means for cooling a return “water-fuel/gas” emulsion;
pressure relief valves for keeping a pressure in the fuel supply lines and preventing formation of a free phase of gas from the “water-fuel/gas” emulsion.

2. The fuel activation system according to claim 1 wherein the absorber has inlet port for receiving the return “water-fuel/gas” emulsion flow from the engine and the discharge port is in fluid connection with the base fuel supply system through an ultrasonic actuator for providing local pressure reliefs thus destroying fuel/gas sorption links without releasing a free phase of gas in the “water-fuel/gas” solution output flow.

3. The fuel activation system as to claim 1 wherein the system further comprises a gas separator for separating free gas/fuel vapors in the return “water-fuel/gas” solution flow; an Y-connector for mixing the return “water-fuel/gas” emulsion flow with the fresh “water-fuel/gas” emulsion flow from the absorber; the resulting mixed “water-fuel/gas” emulsion flow is directed to the base fuel supply system by a recirculation supply pump.

4. The fuel activation system as to claim 1 wherein the water is de-ionized, purified, or desalinated water.

5. The fuel activation system as to claim 1 wherein the gas/gases is fed to the absorber under the pressure of about 500 psi (35 bars).

6. The fuel activation system as to claim 1 wherein the heavy fuel is pumped to the absorber at a pressure of about 1100 psi (75 bars) and taken from a point after heaters and viscosity unit at temperature 185° F. (85° C.).

7. The fuel activation system as to claim 1 wherein the heavy fuel and water is dispersed simultaneously in optimum proportions in the absorber's top area, and a quality of the emulsion is periodically controlled by the presence of separated water in an indicator of transparency of emulsion.

8. A method of improving atomization of heavy fuel oil or diesel fuel wherein before injection into a combustion chamber the fuel is treated by gas/gases under elevated pressure of about 500 psi (35 bars) in an absorber whereas the heavy fuel oil/diesel fuel is fed to the absorber's dispensing means at a pressure of 1100 psi (75 bar); the diesel fuel is fed to the absorber unheated at a temperature not higher than 115° F. (45° C.); a resulted fuel solution does not have a free gas phase; the prepared fuel solution is further mixed with a recirculating fuel stream to form a mixed fuel stream; the mixed fuel stream is directed for injection.

9. A method of improving atomization of heavy fuel oil or diesel fuel wherein before injection into a combustion chamber the fuel is dispersing into an absorber in concurrent with water under elevated gas pressure of about 500 psi (35 psi) forming emulsified fuel solution; both heavy fuel oil/diesel fuel and water are fed to absorber's dispensing means at a pressure of 1100 psi (75 bar); the diesel fuel is fed to absorber unheated at a temperature not higher than 115° F. (45° C.); a resulted emulsified fuel solution does not have a free gas phase; the prepared emulsified fuel solution is further mixed with a recirculating emulsified fuel stream to form a mixed emulsified fuel stream; the mixed emulsified fuel stream is directed for injection.
